(19) United States
(12) Patent Application Publication
(10) Pub. No.: US 2025/0296145 A1
(43) Pub. Date: Sep. 25, 2025

(54) Insulator-Coated Soft Magnetic Powder, Dust Core, Magnetic Element And Electronic Device

(71) Applicant: SEIKO EPSON CORPORATION, Tokyo (JP)

(72) Inventor: Momoko WAKABAYASHI, Hachinohe (JP)

(21) Appl. No.: 19/084,887

(22) Filed: Mar. 20, 2025

(30) Foreign Application Priority Data
Mar. 21, 2024 (JP) 2024-045459

(51) Int. Cl. B22F 1/16; B22F 3/02; C22C 45/02; H01F 1/153; H01F 27/255; H01F 27/28

(52) U.S. Cl. CPC B22F 1/16; B22F 3/02; C22C 45/02; H01F 1/153; H01F 27/255; H01F 27/2895; B22F 2301/35; B22F 2304/10

(57) ABSTRACT

An insulator-coated soft magnetic powder includes: a soft magnetic powder; and an insulating coating configured to cover a surface of a particle of the soft magnetic powder. The soft magnetic powder has an average particle diameter of 2.0 μm or more and 40.0 μm or less, a specific surface area of the insulator-coated soft magnetic powder is 10% or more and 100% or less of a specific surface area of the soft magnetic powder alone, and when the insulator-coated soft magnetic powder is mixed with 2.0 mass % of an epoxy resin and molded under a pressure of 294.2 MPa (3.0 t/cm²), an obtained first molded body has a radial crushing strength of 10 MPa or more.

The present application is based on, and claims priority from JP Application Serial Number 2024-045459, filed Mar. 21, 2024, the disclosure of which is hereby incorporated by reference herein in its entirety.

### BACKGROUND

### 1. Technical Field

The present disclosure relates to an insulator-coated soft magnetic powder, a dust core, a magnetic element, and an electronic device.

### 2. Related Art

JP-A-2021-095629 discloses a soft magnetic material that includes first soft magnetic particles and second soft magnetic particles having a larger average particle diameter, and uses, as the first soft magnetic particles, particles having a non-polar hydrocarbon group or a hydrocarbon group with a linear chain portion having 6 or more carbon atoms on a surface. In such a soft magnetic material, an interaction between the first soft magnetic particles and a binder that binds the soft magnetic material can be reduced, and fluidity of the soft magnetic particles is improved during pressure molding.

In the soft magnetic particles described in JP-A-2021-095629, a non-polar hydrocarbon group or the hydrocarbon group with a straight chain portion having 6 or more carbon atoms is introduced to reduce the interaction with the binder and enhance the fluidity during pressure molding. In a magnetic element using a soft magnetic powder, there is a demand for low iron loss, and as part of this demand, a diameter of the soft magnetic particles is being made smaller. When the diameter of the soft magnetic particles is made smaller, a specific surface area increases, so that it is necessary to increase an amount of binder to be used during pressure molding. However, when the amount of binder to be used increases, a space factor of the soft magnetic particles relatively decreases. As a result, a density of a green compact decreases and magnetic properties decrease. On the other hand, when the amount of binder to be used is reduced, insulation properties and a mechanical strength of the green compact are reduced.

Therefore, an object is to implement an insulator-coated soft magnetic powder that can be used to produce a green compact having high density, high insulation properties, and high mechanical strength.

### SUMMARY

An insulator-coated soft magnetic powder according to an application example of the present disclosure includes:
a soft magnetic powder; and
an insulating coating configured to coat a surface of a particle of the soft magnetic powder, wherein
the soft magnetic powder has an average particle diameter of 2.0 μm or more and 40.0 μm or less,
a specific surface area of the insulator-coated soft magnetic powder is 10% or more and 100% or less of a specific surface area of the soft magnetic powder alone,
when the insulator-coated soft magnetic powder is mixed with 2.0 mass % of an epoxy resin and molded under a pressure of 294.2 MPa (3.0 t/cm²), an obtained first molded body has a radial crushing strength of 10 MPa or more.

A dust core according to an application example of the present disclosure includes:
the insulator-coated soft magnetic powder according to the application example of the present disclosure.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a cross-sectional view schematically showing one particle of an insulator-coated soft magnetic powder according to an embodiment.

FIG. 2 is a process diagram illustrating a method for producing the insulator-coated soft magnetic powder.

FIG. 3 is a plan view schematically showing a toroidal type coil component.

FIG. 4 is a transparent perspective view schematically showing a closed magnetic circuit type coil component.

FIG. 5 is a perspective view showing a mobile personal computer which is an electronic device according to the embodiment.

FIG. 6 is a plan view showing a smartphone which is an electronic device according to the embodiment.

FIG. 7 is a perspective view showing a digital still camera which is an electronic device according to the embodiment.

### DESCRIPTION OF EMBODIMENTS

Hereinafter, an insulator-coated soft magnetic powder, a dust core, a magnetic element, and an electronic device according to the present disclosure will be described in detail based on a preferred embodiment shown in the accompanying drawings.

### 1. Insulator-Coated Soft Magnetic Powder

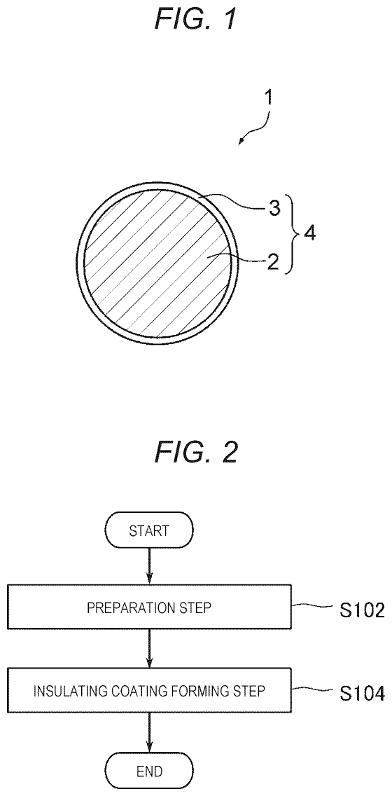

First, an insulator-coated soft magnetic powder according to an embodiment will be described. FIG. 1 is a cross-sectional view schematically showing one particle of an insulator-coated soft magnetic powder 1 according to the embodiment. In the following description, each particle of the insulator-coated soft magnetic powder 1 is also referred to as an “insulator-coated soft magnetic particle 4”.

The insulator-coated soft magnetic particle 4 shown in FIG. 1 includes a soft magnetic particle 2 and an insulating coating 3 provided on a surface of the soft magnetic particle 2. Among these, the soft magnetic particle 2 contains a soft magnetic material to be described later. The insulating coating 3 is provided to cover the surface of the soft magnetic particle 2, and has insulation properties. The coating described in the present disclosure is a concept including not only a state of covering the entire surface of the soft magnetic particle 2 but also a state of covering a part of the surface. In the following description, an aggregate of the soft magnetic particles 2 is also referred to as a “soft magnetic powder”.

An average particle diameter of the soft magnetic powder is 2.0 μm or more and 40.0 μm or less. A specific surface area of the insulator-coated soft magnetic powder 1 is 10% or more and 100% or less of a specific surface area of the soft magnetic powder alone. Further, in the insulator-coated soft magnetic powder 1, when the insulator-coated soft magnetic powder is mixed with 2.0 mass % of an epoxy resin and molded under a pressure of 294.2 MPa (3.0 t/cm²), an obtained first molded body has a radial crushing strength of 10 MPa or more.

According to such a configuration, the insulator-coated soft magnetic powder 1 is implemented so that the specific surface area is kept to be small, and the radial crushing strength of a molded body formed under a predetermined condition is sufficiently high. Therefore, in a green compact obtained by compacting the insulator-coated soft magnetic powder 1, high insulation properties can be obtained, as well as high molding density and high mechanical strength.

### 1.1. Soft Magnetic Powder

### 1.1.1. Composition of Soft Magnetic Material

The soft magnetic particle 2 is made of a soft magnetic material. The soft magnetic material may be, for example, a material containing at least one of Fe, Ni, and Co as a main component, that is, a material containing 50% or more of these elements in terms of atomic ratio. In addition to these main component elements, the soft magnetic material may contain at least one element selected from the group including Cr, Nb, Cu, Al, Mn, Mo, Si, Sn, B, C, P, Ti and Zr, depending on target characteristics. The soft magnetic material may contain inevitable impurities as long as the effects of the embodiment are not impaired. The inevitable impurities are impurities unintentionally mixed in raw materials or during production. The inevitable impurities include any elements other than those described above, and examples thereof include O, N, S, Na, Mg, K, and the like.

Specific examples of the soft magnetic material include Fe—Si alloys such as silicon steel, Fe—Si—Al alloys such as sendust, as well as various alloys such as Fe—Ni based alloys, Fe—Co based alloys, Fe—Ni—Co based alloys, Fe—Si—B based alloys, Fe—Si—B—C based alloys, Fe—Si—B—Cr—C based alloys, Fe—Si—Cr based alloys, Fe—B based alloys, Fe—P—C based alloys, Fe—Co—Si—B based alloys, Fe—Si—B—Nb based alloys, Fe—Si—B—Nb—Cu based alloys, Fe—Zr—B based alloys, Fe—Cr based alloys, and Fe—Cr—Al based alloys, Ni based alloys such as Ni—Si—B based alloys and Ni—P—B based alloys, and Co based alloys such as Co—Si—B based alloys.

By using a soft magnetic material having such a composition, the insulator-coated soft magnetic powder 1 having high magnetic properties such as permeability and magnetic flux density and coercive force can be obtained.

In the soft magnetic material, a content of the main component is preferably 50% or more, and more preferably 70% or more, in terms of atomic ratio. Accordingly, it is possible to particularly enhance the magnetic properties of the insulator-coated soft magnetic powder 1, such as the permeability and the magnetic flux density.

A structure constituting the soft magnetic material is not particularly limited, and may be any of a crystalline structure, a non-crystalline (amorphous) structure, or a microcrystalline (nanocrystalline) structure. Among these, the soft magnetic material preferably contains an amorphous alloy having an amorphous structure or a nanocrystalline alloy having a nanocrystalline structure. By containing these, the coercive force is reduced, and hysteresis loss of the magnetic element is reduced. In the soft magnetic material, structures having different crystallinity may be mixed.

Examples of the amorphous alloy material and the nanocrystalline alloy material include Fe-based alloys such as Fe—Si—B based, Fe—Si—B—C based, Fe—Si—B—Cr—C based, Fe—Si—Cr based, Fe—B based, Fe—P—C based, Fe—Co—Si—B based, Fe—Si—B—Nb based, Fe—Si—B—Nb—Cu based, and Fe—Zr—B based alloys, Ni-based alloys such as Ni—Si—B based and Ni—P—B based alloys, and Co-based alloys such as Co—Si—B based alloys.

In particular, the soft magnetic particle 2 is preferably made of an amorphous alloy material having the following composition formula. Accordingly, the soft magnetic particle 2 having both high permeability and low coercive force is obtained.

Composition formula: (Fe₁₋ₓCrₓ)ₐ(Si_{1-y}B_{y})_{100-a-b}C_{b}

[In the above formula, x, y, a, and b are 0<x≤0.06, 0.3≤y≤0.7, 70.0≤a≤81.0, and 0<b≤3.0.]

The composition formula represents a ratio in terms of the number of atoms in a composition containing five elements of Fe, Cr, Si, B, and C.

Fe (iron) greatly affects basic magnetic properties and mechanical properties of the soft magnetic particle 2.

A content of Fe is not particularly limited, and is set such that Fe is a main component, that is, the ratio in terms of the number of atoms is the highest in the soft magnetic particle 2. In the soft magnetic particle 2, the content of Fe is preferably 70.0 atomic % or more and 78.0 atomic % or less, more preferably 71.0 atomic % or more and 77.0 atomic % or less, and still more preferably 72.0 atomic % or more and 75.0 atomic % or less.

Cr (chromium) acts to improve corrosion resistance of the soft magnetic particle 2. By improving the corrosion resistance, oxidation of particles is inhibited, and deterioration in the magnetic properties due to the oxidation can be inhibited. A passive film also enhances the insulation properties of the particles and contributes to preventing eddy current loss in the magnetic element.

x represents a ratio of a content of Cr to a total content when a total of the content of Fe and the content of Cr is 1. In the soft magnetic particle 2, 0<x≤0.06 is preferable, 0.01≤x≤0.05 is more preferable, and 0.02≤x≤0.04 is still more preferable.

a represents a ratio of the total of the content of Fe and the content of Cr, and is preferably 70.0≤a≤ 81.0, more preferably 73.0≤a≥80.0, and still more preferably 75.0≤a≤77.0.

When producing the soft magnetic particle 2 from a raw material, Si (silicon) promotes amorphization and enhances the permeability of the soft magnetic particle 2. Accordingly, high permeability and low coercive force can be achieved.

B (boron) promotes the amorphization when the soft magnetic particle 2 is produced from a raw material. In particular, by using Si and B in combination, the amorphization can be synergistically promoted based on a difference in an atomic radius between Si and B. Accordingly, high permeability and low coercive force can be sufficiently achieved.

y represents a ratio of a content of B to a total content when a total of the content of Si and the content of B is 1. In the soft magnetic particle 2, 0.3≤ y≤0.7 is preferable, and 0.4≤y≤0.6 is more preferable.

A content of Si is preferably 8.0 atomic % or more and 13.5 atomic % or less, and more preferably 10.5 atomic % or more and 12.0 atomic % or less.

A content of B is preferably 8.0 atomic % or more and 13.5 atomic % or less, and more preferably 10.5 atomic % or more and 12.0 atomic % or less.

Carbon (C) lowers viscosity of a molten material when the raw material for the soft magnetic particle 2 is melted, facilitating amorphization and pulverization. Accordingly, the soft magnetic particle 2 having a small diameter and high permeability can be obtained. As a result, the eddy current loss can be reduced even in a high-frequency range.

b represents the content of C. In the soft magnetic particle 2, 0<b≥3.0 is preferable, 1.0≤b≥2.8 is more preferable, and 1.5≤b≥2.5 is still more preferable.

The composition of the soft magnetic material is identified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge atomic emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specifically, examples thereof include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur(S), an infrared absorption method after combustion in a current t of oxygen (combustion in high frequency induction furnace) defined in JIS G 1211:2011 is also used. Specifically, an example thereof is a carbon and sulfur analyzer CS-200 manufactured by LECO Corporation.

When nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen and nitrogen analyzer, TC-300/EF-300, manufactured by LECO Corporation.

### 1.1.2. Particle Size Distribution

In a particle size distribution of the soft magnetic powder on a volume basis, when a particle diameter at which a cumulative frequency is 50% is defined as an average particle diameter, the average particle diameter of the soft magnetic powder is 2.0 μm or more and 40.0 μm or less, preferably 8.0 μm or more and 35.0 μm or less, and more preferably 15.0 μm or more and 30.0 μm or less.

When the average particle diameter of the soft magnetic powder is within the above range, since the particle size distribution is optimized, the insulator-coated soft magnetic powder 1 having particularly good fluidity and capable of producing a high-density green compact can be obtained. In addition, since the specific surface area can be kept relatively small, an amount of binder (binding material) to be used during compaction can be reduced. Accordingly, the space factor of the soft magnetic powder contained in the green compact can be enhanced, and the green compact having excellent magnetic properties can be obtained.

When the average particle diameter of the soft magnetic powder is less than the lower limit aggregation is likely to occur, making it difficult to form the insulating coating 3, and a filling property during compaction is reduced, making a density of the green compact likely to decrease. On the other hand, when the average particle diameter of the soft magnetic powder is more than the upper limit value, a surface area becomes small, and thus a binding force between the particles decreases, and the mechanical strength of the green compact is likely to decrease. A degree of difficulty in producing the soft magnetic powder increases, and production efficiency decreases.

A volume-based particle size distribution of the soft magnetic powder can be obtained using, for example, a laser diffraction type particle size distribution measurement device.

### 1.2. Insulating Coating

The insulating coating 3 covers the surface of the soft magnetic particle 2. The insulating coating 3 shown in FIG. 1 is preferably made of an inorganic material, and more preferably contains an inorganic oxide. Accordingly, even when the insulating coating 3 is thin, sufficient insulation properties can be obtained.

### 1.2.1. Constituent Material of Insulating Coating

Examples of constituent components of the inorganic material include inorganic oxides and inorganic non-oxides.

Examples of inorganic oxides include silicon oxides such as SiO₂, magnesium oxides such as MgO, calcium oxides such as Cao, aluminum oxides such as Al₂O₃, titanium oxides such as SiOz, zirconium oxides such as Zroz, boron oxides such as B₂O₃, yttrium oxides such as Y₂O₃, phosphorus oxides such as P₂O₅, bismuth oxides such as Bi₂O₃, zinc oxides such as Zno, tin oxides such as Sno, lead oxides such as PbO, lithium oxides such as Li₂O, sodium oxides such as Na₂O, potassium oxides such as K₂O, strontium oxides such as Sro, barium oxides such as Bao, gadolinium oxides such as Gd₂O₃, lanthanum oxides such as La₂O₃, and ytterbium oxides such as Yb₂O₃. These composition formulas are merely examples showing the composition ratios of the compounds, and the compounds may have composition ratios other than those described above.

Examples of inorganic non-oxides include silicon nitride such as Si₃N₄, aluminum nitride such as AlN, boron nitride such as BN, titanium nitride such as TiN, and tungsten nitride such as WN.

Among these, the insulating coating 3 preferably contains an inorganic oxide, and more preferably contains a silicon oxide or an aluminum oxide. These have particularly good insulation properties and chemical stability, and are readily available. Therefore, the insulating coating 3 that has good insulation properties for a long period of time is obtained.

The insulating coating 3 may contain components other than those described above. The content of the above components in the insulating coating 3 is preferably 50 mass % or more, more preferably 70 mass % or more, and still more preferably 90 mass % or more. Accordingly, the insulating coating 3 has particularly good insulation properties.

The surface of the insulating coating 3 may be subjected to a coupling agent treatment or the like as necessary.

### 1.2.2. Average Thickness

An average thickness of the insulating coating 3 is preferably 1 nm or more and 100 nm or less, more preferably 5 nm or more and 70 nm or less, and still more preferably 10 nm or more and 50 nm or less. When the average thickness of the insulating coating 3 is within the above range, the insulation properties of the insulating coating 3 can be sufficiently ensured while the space factor of the insulating coating 3 in the dust core can be reduced and a filling rate of the soft magnetic particles 2 can be enhanced. In addition, when the surface of the soft magnetic particle 2 is uneven, the insulating coating 3 smooths out the unevenness and also contributes to making the particles closer to a spherical shape. Accordingly, the fluidity of the insulator-coated soft magnetic powder 1 can be further enhanced.

When the average thickness of the insulating coating 3 is less than the lower limit value, the insulation properties of the insulating coating 3 are insufficient, and the unevenness of the surface of the soft magnetic particle 2 may not be sufficiently smoothed. On the other hand, when the average thickness of the insulating coating 3 is more than the upper limit value, the insulating coating 3 may be easily peeled off, or the space factor of the soft magnetic particles 2 in the green compact may decrease.

The average thickness of the insulating coating 3 is measured, for example, by magnifying and observing a cross section of the insulator-coated soft magnetic particle 4. Specifically, the insulator-coated soft magnetic particle 4 is cut by a focused ion beam to prepare a cross-sectional thin sample. Next, the obtained cross-sectional thin sample is observed with a scanning transmission electron microscope, and a thickness of the insulating coating 3 is measured at five or more positions for one insulator-coated soft magnetic particle 4. Further, measured values are averaged, and a calculation result is taken as the average thickness of the insulating coating 3. A distribution range of the insulating coating 3 in an observation image can be more clearly confirmed more clearly by using, for example, energy dispersive X-ray analysis (EDX analysis), Auger electron spectroscopy, or the like in combination.

1.2.3. Oxygen Content Derived from Insulating Coating

An oxygen content derived from the insulating coating 3 is preferably 500 ppm or more and 7000 ppm or less, more preferably 700 ppm or more and 5000 ppm or less, and still more preferably 900 ppm or more and 3000 ppm or less in terms of mass ratio. When the oxygen content derived from the insulating coating 3 is within the above range, the insulation properties of the insulating coating 3 can be particularly enhanced. Therefore, even when a film thickness of the insulating coating 3 is thin, the insulator-coated soft magnetic particle 4 that has excellent insulation properties between the particles and can produce, for example, a green compact having excellent withstand voltage can be obtained. In addition, when the oxygen content derived from the insulating coating 3 is within the above range, adhesion of the insulating coating 3 to the soft magnetic particles 2 is increased, and for example, a green compact having excellent mechanical strength can be produced.

When the oxygen content is less than the lower limit value, the insulation properties of the insulating coating 3 and the adhesion to the soft magnetic particles 2 may decrease. On the other hand, when the oxygen content is more than the upper limit value, the space factor of the insulating coating 3 is increased, and thus, for example, the magnetic properties of the green compact may decrease.

The oxygen content derived from the insulating coating 3 is calculated by subtracting the oxygen content derived from the soft magnetic particles 2 from the oxygen content of the insulator-coated soft magnetic powder 1. Each oxygen content is measured according to, for example, the general rule of oxygen quantification method of a metal material specified in JIS Z 2613:2006. Specifically, measurement can be performed using an oxygen/nitrogen analyzer, TC-300/EF-300 made by LECO Corporation, an oxygen/nitrogen/hydrogen analyzer, ONH 836 made by LECO Corporation, or the like.

The oxygen content derived from the soft magnetic particles 2 can also be obtained by removing the insulating coating 3 from the insulator-coated soft magnetic powder 1 by a removal method such as ion sputtering and then measuring the oxygen content by the above-described measurement method.

### 1.3. Properties of Insulator-Coated Soft Magnetic Powder

Next, properties of the insulator-coated soft magnetic powder 1 will be described.

### 1.3.1. Specific Surface Area

The specific surface area of the insulator-coated soft magnetic powder 1 is set within the following range when a specific surface area of a portion excluding the insulating coating 3 from the insulator-coated soft magnetic powder 1, that is, the specific surface area of the soft magnetic powder alone, is taken as the standard. Hereinafter, the ratio will be referred to as a “specific surface area ratio”.

The specific surface area ratio of the insulator-coated soft magnetic powder 1 is set to 10% or more and 100% or less. The content is preferably 15% or more and 80% or less, and more preferably 20% or more and 60% or less. When the specific surface area ratio of the insulator-coated soft magnetic powder 1 is within the above range, it is confirmed that the unevenness of the surface of the soft magnetic particle 2 is uniformly filled by the formation of the insulating coating 3. Therefore, even when the particle diameter of the soft magnetic powder is small, the insulator-coated soft magnetic powder 1 having excellent fluidity and filling property can be obtained. According to the insulator-coated soft magnetic powder 1, it is possible to implement a green compact having a high density and a reduced amount of binder. Such a green compact has a high density, high insulation properties, and a high mechanical strength.

When the specific surface area ratio is less than the lower limit value, a sufficient thickness is required for the insulating coating 3, and thus the space factor of the insulating coating 3 in the green compact increases. In addition, a contact area between the insulator-coated soft magnetic powder 1 and the binding material decreases, and the mechanical strength of the green compact decreases. On the other hand, when the specific surface area ratio is more than the upper limit value, the filling property of the insulator-coated soft magnetic powder 1 during compaction decreases, and the density, the mechanical strength, the magnetic properties, and the like of the green compact decrease.

The specific surface area of the insulator-coated soft magnetic powder 1 is preferably 0.010 m²/g or more and 0.600 m²/g or less, more preferably 0.015 m²/g or more and 0.300 m²/g or less, and still more preferably 0.020 m²/g or more and 0.100 m²/g or less. When the specific surface area is within the above range, the aggregation due to surface energy is reduced, and therefore, the filling property of the insulator-coated soft magnetic powder 1 during compaction is enhanced. When the specific surface area is within the above range, an occupancy rate of the insulating coating 3 in the green compact can be optimized. As a result, the density and the mechanical strength of the green compact can be enhanced, and a decrease in the permeability of the green compact can be prevented.

When the specific surface area is less than the lower limit value, the contact area between the insulator-coated soft magnetic powder 1 and the binding material decreases, and the mechanical strength of the green compact may decrease. On the other hand, when the specific surface area is more than the upper limit value, the filling property during compaction decreases, and the density, the mechanical strength, the magnetic properties, and the like of the green compact may decrease.

The specific surface area of the insulator-coated soft magnetic powder 1 and the specific surface area of the soft magnetic powder are each obtained by a BET method. As a specific surface area measurement device, for example, a BET type specific surface area measurement device HM1201-010 manufactured by Mountech Co., Ltd. may be used, and a specimen amount is 5 g.

### 1.3.2. Radial Crushing Strength

The insulator-coated soft magnetic powder 1 has a radial crushing strength of 10 MPa or more when the first molded body is formed under predetermined conditions. The radial crushing strength is preferably 10 MPa or more and 55 MPa or less, more preferably 15 MPa or more and 45 MPa or less, and still more preferably 20 MPa or more and 35 MPa or less. The insulator-coated soft magnetic powder 1 that achieves such radial crushing strength contributes to the implementation of a dust core (green compact) having a good mechanical strength.

When the radial crushing strength is less than the lower limit value, defects such as chipping and cracking may occur when a load such as a strong impact is applied to the dust core. On the other hand, the radial crushing strength may be more than the upper limit value, but in this case, a variation in the mechanical strength of the dust core may increase.

A method for measuring the radial crushing strength is as follows.

First, the insulator-coated soft magnetic powder 1 is mixed with 2.0 mass % of epoxy resin relative to the mass of the powder, dried at 50° C. for 1 hour, and then crushed to obtain a granulated powder. Next, the obtained granulated powder is press-molded at a pressure of 294.2 MPa (3 t/cm²), and then heated at 150° C. for 3 hours to cure the epoxy resin. Accordingly, the first molded body is obtained. The first molded body is formed into an annular shape having an outer diameter of 14 mm, an inner diameter of 8 mm, and a thickness of 3 mm. Next, a radial crushing strength of the obtained first molded body is measured. A method for measuring the radial crushing strength is a method according to a radial crushing strength test method defined in JIS Z 2507:2000. Specifically, when the radial crushing strength is K, the outer diameter is D, a radial wall thickness (half a difference between the outer diameter and the inner diameter) is t, the thickness is L, and a breaking load is F, the radial crushing strength K is obtained by K=F (D−t)/(Lt²).

### 1.3.3. Density of Molded Body

The density of the first molded body obtained as described above is preferably 4.40 g/cm³ or more and 5.00 g/cm³ or less, more preferably 4.50 g/cm³ or more and 4.95 g/cm³ or less, and still more preferably 4.60 g/cm³ or more and 4.90 g/cm³ or less. When the density of the first molded body is within the above range, it is possible to implement the insulator-coated soft magnetic powder 1 that can be used to produce a high-density dust core. Further, such a dust core makes it possible to implement a magnetic element having high magnetic properties.

The density of the first molded body is obtained by dividing the mass of the first molded body obtained as described above by the volume.

### 1.3.4. Withstand Voltage

The insulator-coated soft magnetic powder 1 has a second molded body formed under predetermined conditions, and a withstand voltage of the second molded body is preferably 200 V/mm or more, more preferably 200 V/mm or more and 4000 V/mm or less, still more preferably 300 V/mm or more and 3000 V/mm or less, and particularly preferably 400 V/mm or more and 2000 V/mm or less. The insulator-coated soft magnetic powder 1 that achieves such a withstand voltage contributes to the implementation of a magnetic element that is small but has a high rated voltage.

When the withstand voltage is less than the lower limit value, the rated voltage of the magnetic element may not be sufficiently enhanced. On the other hand, the withstand voltage may be more than the upper limit value, but in this case, a variation in the withstand voltage of the magnetic element may increase.

A method for measuring the withstand voltage is as follows.

First, the insulator-coated soft magnetic powder 1 is mixed with 2.0 mass % of epoxy resin relative to the mass of the powder, dried at 50° C. for 1 hour, and then crushed to obtain a granulated powder. Next, the obtained granulated powder is press-molded at a pressure of 49.0 MPa (0.5 t/cm²) into a cylindrical shape with a height of 5 mm, and then heated at 150° C. for 30 minutes to cure the epoxy resin. Accordingly, the second molded body is obtained. In the press molding, a copper electrode having a thickness of 1 mm is embedded in each of upper and lower surfaces of the cylinder.

Next, each electrode is coupled to a power supply device, and a DC voltage is applied between the electrodes. Then, while increasing the voltage in increments of 50 V, an electrical resistance value between the electrodes is measured with a digital multimeter. The voltage at which the electrical resistance value is 1 MΩ or less is defined as a dielectric breakdown voltage. For example, when the electrical resistance value is 1 MΩ or less when the voltage is 550V, the dielectric breakdown voltage is set to 500V.

Next, the dielectric breakdown voltage is divided by a distance between the electrodes to obtain the withstand voltage. For example, when the dielectric breakdown voltage is 500 V and the distance between the electrodes is 3 mm, the withstand voltage is 167 V/mm.

### 2. Production Method for Insulator-Coated Soft Magnetic Powder

Next, an example of a method for producing the insulator-coated soft magnetic powder 1 will be described.

FIG. 2 is a process diagram illustrating a method for producing the insulator-coated soft magnetic powder 1.

The method for producing an insulator-coated soft magnetic powder shown in FIG. 2 includes a preparation step S102 and an insulating coating forming step S104.

### 2.1. Preparation Step

In the preparation step S102, a soft magnetic powder is prepared. The soft magnetic powder may be a powder produced using any method. Examples of the production method include various atomization methods such as water atomization method, gas atomization, and rotary water jet atomization method, as well as reduction, carbonyl, and pulverization methods. Among these, the atomization method is preferably used. That is, the soft magnetic powder is preferably an atomized powder. The atomized powder is tiny, highly spherical, and has high production efficiency. In particular, a water atomized powder or a rotary water flow atomized powder is produced by contact between molten metal and water, and thus has a thin oxide film on a surface. This oxide film can serve as a base for the insulating coating 3. Therefore, adhesion between the soft magnetic particle 2 and the insulating coating 3 is excellent, which ultimately results in the insulator-coated soft magnetic powder 1 having particularly high insulation properties between particles. In addition, since a cooling rate is high, it is possible to produce a soft magnetic powder including an amorphous structure or a nanocrystalline structure.

The water atomization method is a method for producing a metal powder by spraying cooling water in an inverted cone shape and passing molten metal through the water. According to the water atomization method, it is possible to efficiently produce a soft magnetic powder having a relatively small particle diameter.

The rotary water jet atomization method is a method for producing a metal powder by rotating cooling water along an inner surface of a vessel and bringing finely divided molten metal into contact with the water. According to the rotary water jet atomization method, it is possible to efficiently produce a soft magnetic powder having a relatively large particle diameter.

### 2.2. Insulating Coating Forming Step

In the insulating coating forming step S104, the insulating coating 3 that covers the surface of the soft magnetic particle 2 is formed.

A method for forming the insulating coating 3 is not particularly limited, and examples thereof include a mechanochemical method, a gas phase film formation method, and a liquid phase film formation method.

Examples of the gas phase film formation method include a plasma polymerization method, an atomic layer deposition (ALD) method, a chemical vapor deposition (CVD) method, and an ion plating method.

Examples of the liquid phase film formation method include a sol-gel method and an electrolytic reduction method.

The mechanochemical method and the sol-gel method will be described below as representative methods.

### 2.2.1. Mechanochemical Method

The mechanochemical method is a method in which a mechanical stress is applied to ceramic particles to change physicochemical properties of the ceramic particles. For example, by using a mechanochemical reaction device having a cylindrical chamber that rotates at a high speed and is provided with a compression tool and a blade inside, a mechanical interaction (mechanochemical reaction) is generated between the soft magnetic particle 2 and inorganic material particles, and the insulating coating 3 made of an inorganic material can be formed on the surface of the soft magnetic particle 2. By using such a mechanical coating formation method, the insulating coating 3 can be favorably adhered even when contaminants are attached to the surface of the soft magnetic particle 2 or when the adhesion is low. Further, since the insulating coating 3 is not subjected to high temperature conditions during the formation of the insulating coating 3, thermal denaturation of the soft magnetic particle 2, such as unintended crystal coarsening, can be prevented. Accordingly, it is possible to prevent the soft magnetism of the soft magnetic particles 2 from decreasing.

Examples of the mechanochemical reaction device include a “Nobilta” (registered trademark) pulverizer and a “Mechanofusion” (registered trademark) pulverizer manufactured by Hosokawa Micron Corporation, and a “Hybridizer” (registered trademark) pulverizer manufactured by Nara Machinery Works, Ltd.

### 2.2.2. Sol-Gel Method

The sol-gel method is a method for preparing an inorganic oxide by hydrolysis of a metal alkoxide. For example, when forming the insulating coating 3 from silicon oxide, a hydrolysis reaction of silicon alkoxide can be utilized. The method using silicon alkoxide will be described below.

First, the soft magnetic particles 2 are dispersed in an alcohol solution containing silicon alkoxide. The alcohol solution includes lower alcohols such as ethanol and methanol. For example, 10 parts by mass or more and 50 parts by mass or less of alcohol may be mixed with 1 part by mass of tetraethoxysilane.

Next, aqueous ammonia is mixed in as a catalyst to promote the reaction, causing hydrolysis. Accordingly, a dehydration condensation reaction occurs between the hydrolysates and between the hydrolysates and the silicon alkoxide to form —Si—O—Si— bonds on the particle surfaces. Accordingly, the insulating coating 3 made of silicon oxide is formed. Thereafter, the insulating coating 3 may be heated as necessary.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, an electromagnetic valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is an example of the magnetic element according to the embodiment, will be described.

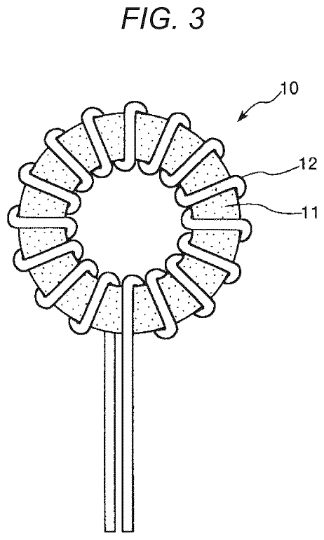

FIG. 3 is a plan view schematically showing a toroidal type coil component 10.

The coil component 10 shown in FIG. 3 includes a ring-shaped dust core 11 and a conductive wire 12 wound around the dust core 11. Such a coil component 10 is generally called a toroidal coil.

The dust core 11 is obtained by mixing the insulator-coated soft magnetic powder 1 according to the embodiment with a binding material and compacting the resulting mixture. Since the dust core 11 is a green compact containing the insulator-coated soft magnetic powder 1 according to the embodiment, it is possible to implement the coil component 10 that achieves both magnetic properties, insulation properties, and a mechanical strength. Therefore, when the coil component 10 is mounted in an electronic device or the like, the electronic device or the like can have high performance and a small size.

Examples of a constituent material of the binding material to be used for preparing the dust core 11 include organic materials such as silicone-based resins, epoxy-based resins, phenol-based resins, polyamide-based resins, thermosetting polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate, with thermosetting polyimide-based resins and epoxy-based resins being particularly preferred. These resin materials are easily cured by heating and have excellent heat resistance. Therefore, ease of producing the dust core 11 and heat resistance thereof can be enhanced.

A ratio of the binding material to the insulator-coated soft magnetic powder 1 varies slightly depending on desired magnetic properties and mechanical properties of the dust core 11 to be prepared, allowable eddy current loss, and the like, and is preferably approximately 0.3 mass % or more and 5.0 mass % or less, more preferably approximately 0.5 mass % or more and 3.0 mass % or less, and still more preferably approximately 0.7 mass % or more and 2.0 mass % or less. Accordingly, the coil component 10 having excellent magnetic properties can be obtained while the particles of the insulator-coated soft magnetic powder 1 are sufficiently bonded to each other.

If necessary, various additives may be added to the mixture as necessary for any purpose.

Examples of a constituent material of the conductive wire 12 include a material having high conductivity, for example, a metal material including Cu, Al, Ag, Au, and Ni. An insulating coating film may be provided on a surface of the conductive wire 12 as necessary.

A shape of the dust core 11 is not limited to the ring shape shown in FIG. 3, and may be, for example, a shape in which a part of the ring is missing, or a shape in which a shape in a longitudinal direction is linear.

The dust core 11 may contain, as necessary, a soft magnetic powder other than the insulator-coated soft magnetic powder 1 according to the embodiment described above, or a non-magnetic powder.

### 3.2. Closed Magnetic Circuit Type

Next, a closed magnetic circuit type coil component, which is an example of the magnetic element according to the embodiment, will be described.

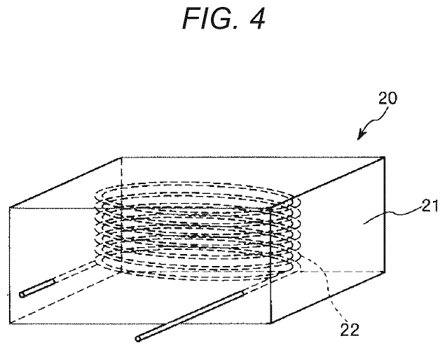

FIG. 4 is a transparent perspective view schematically showing a closed magnetic circuit type coil component 20.

Hereinafter, the closed magnetic circuit type coil component 20 will be described. In the following description, differences from the toroidal type coil component 10 will mainly be described, and description of similar matters will be omitted.

As shown in FIG. 4, the coil component 20 according to the embodiment is formed by embedding a conductive wire 22 formed in a coil shape inside a dust core 21. That is, the coil component 20 which is a magnetic element includes the dust core 21 containing the above-described insulator-coated soft magnetic powder 1, and is formed by molding the conductive wire 22 with the dust core 21. The dust core 21 has a configuration same as that of the dust core 11 described above. Accordingly, the coil component 20 having high magnetic properties, insulation properties, and mechanical strength can be implemented.

The coil component 20 having such a configuration is easy to have a relatively small size. Therefore, when the coil component 20 is mounted in an electronic device or the like, the electronic device or the like can have high performance and a small size.

Since the conductive wire 22 is embedded in the dust core 21, a gap is less likely to be formed between the conductive wire 22 and the dust core 21. Therefore, vibration caused by magnetostriction of the dust core 21 can be prevented, and generation of noise due to the vibration can also be prevented.

A shape of the dust core 21 is not limited to the shape shown in FIG. 4, and may be a sheet-like shape, a film-like shape, or the like.

The dust core 21 may contain, as necessary, a soft magnetic powder other than the insulator-coated soft magnetic powder 1 according to the embodiment described above, or a non-magnetic powder.

### 4. Electronic Device

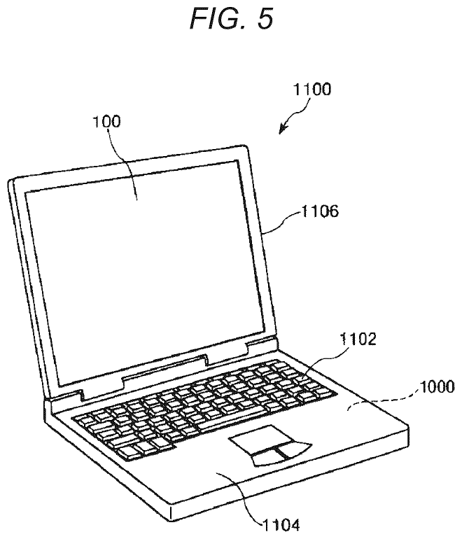

Next, the electronic device including the magnetic element according to the embodiment will be described with reference to FIGS. 5 to 7.

FIG. 5 is a perspective view showing a mobile personal computer 1100 which is the electronic device according to the embodiment. A personal computer 1100 shown in FIG. 5 includes a main body 1104 including a keyboard 1102 and a display unit 1106 including a display 100. The display unit 1106 is pivotally supported by the main body 1104 via a hinge structure. Such a personal computer 1100 includes therein a magnetic element 1000 such as a choke coil, an inductor, or a motor for a switching power supply.

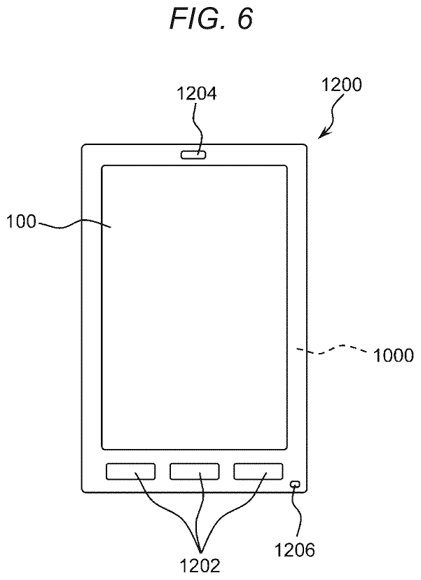

FIG. 6 is a plan view showing a smartphone 1200 which is the electronic device according to the embodiment. A smartphone 1200 shown in FIG. 6 includes a plurality of operation buttons 1202, an earpiece 1204, and a mouthpiece 1206. The display 100 is disposed between the operation buttons 1202 and the earpiece 1204. Such a smartphone 1200 includes therein the magnetic element 1000 such as an inductor, a noise filter, or a motor.

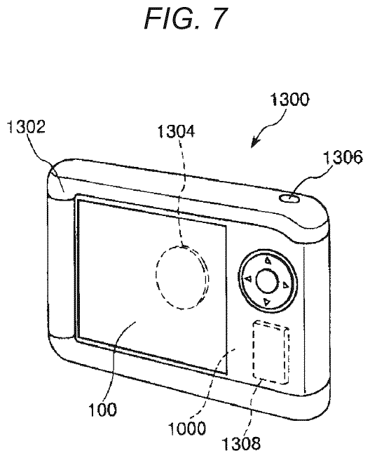

FIG. 7 is a perspective view showing a digital still camera 1300 which is the electronic device according to the embodiment. The digital still camera 1300 photoelectrically converts an optical image of a subject with an imaging element such as a charge coupled device (CCD) to generate an imaging signal.

The digital still camera 1300 shown in FIG. 7 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

Examples of the electronic device according to the embodiment include, in addition to the personal computer 1100 in FIG. 5, the smartphone 1200 in FIG. 6, and the digital still camera 1300 in FIG. 7, a mobile phone, a tablet terminal, a watch, inkjet discharge apparatuses such as an inkjet printer, a laptop personal computer, a television, a video camera, a video tape recorder, a car navigation apparatus, a pager, an electronic notebook, an electronic dictionary, a calculator, an electronic game console, a word processor, a workstation, a videophone, a security television monitor, electronic binoculars, a POS terminal, medical devices such as an electronic thermometer, a blood pressure meter, a blood glucose meter, an electrocardiogram measurement apparatus, an ultrasonic diagnostic apparatus, and an electronic endoscope, a fish finder, various measuring devices, instruments for a vehicle, an aircraft, and a ship, vehicle control devices such as an automobile control device, an aircraft control device, a railway vehicle control device, and a ship control device, and a flight simulator.

Such an electronic device includes the magnetic element according to the embodiment, as described above. Accordingly, it is possible to enjoy the effect of the magnetic element according to the embodiment in which the magnetic properties, the insulation properties, and the mechanical strength are compatible, and to achieve high performance and small size of the electronic device.

### 5. Effects of Embodiment

As described above, the insulator-coated soft magnetic powder 1 according to the embodiment includes a soft magnetic powder and the insulating coating 3. The insulating coating 3 covers surfaces of the soft magnetic particles 2 (particle surfaces of the soft magnetic powder). The soft magnetic powder has an average particle diameter of 2.0 μm or more and 40.0 μm or less. Further, a specific surface area of the insulator-coated soft magnetic powder 1 is 10% or more and 100% or less of a specific surface area of the soft magnetic powder alone. In the insulator-coated soft magnetic powder 1, when the insulator-coated soft magnetic powder is mixed with 2.0 mass % of an epoxy resin and molded under a pressure of 294.2 MPa (3.0 t/cm²), an obtained first molded body has a radial crushing strength of 10 MPa or more.

According to such a configuration, the insulator-coated soft magnetic powder 1 that can be used to produce a green compact having high density, high insulation properties, and high mechanical strength can be obtained.

In the insulator-coated soft magnetic powder 1 according to the embodiment, the insulating coating 3 contains an inorganic oxide.

According to such a configuration, since the insulation properties and the chemical stability of the inorganic oxide are particularly good, the insulating coating 3 having good insulation properties over a long period of time can be obtained.

In the insulator-coated soft magnetic powder 1 according to the embodiment, when the insulator-coated soft magnetic powder is mixed with 2.0 mass % of an epoxy resin and molded at a pressure of 49.0 MPa (0.5 t/cm²), an obtained second molded body has a withstand voltage of 200 V/mm or more.

According to such a configuration, the insulator-coated soft magnetic powder 1 that contributes to the implementation of a magnetic element that is small but has a high rated voltage can be obtained.

In the insulator-coated soft magnetic powder 1 according to the embodiment, the specific surface area is 0.010 m²/g or more and 0.600 m²/g or less.

According to such a configuration, an aggregation due to surface energy is reduced, and therefore, a filling property of the insulator-coated soft magnetic powder 1 during compaction is enhanced. When the specific surface area is within the above range, an occupancy rate of the insulating coating 3 in the green compact can be optimized. As a result, it is possible to obtain the insulator-coated soft magnetic powder 1 capable of enhancing a density and a mechanical strength of a green compact and preventing a decrease in permeability of the green compact.

In the insulator-coated soft magnetic powder 1 according to the embodiment, the soft magnetic particle 2 (particle of soft magnetic powder) is formed of an amorphous alloy material having a composition represented by a composition formula (Fe₁₋ₓCrₓ)ₐ(Si_{1-y}B_{y})_{100-a-b}C_{b} expressed in terms of atomic ratio, where x, y, a and b are 0<x≤0.06, 0.3≤y≤ 0.7, 70.0≤ a≤ 81.0, and 0<b≤3.0.

According to such a configuration, the soft magnetic particle 2 having both high permeability and low coercive force are obtained.

In the insulator-coated soft magnetic powder 1 according to the embodiment, a density of the first molded body is 4.40 g/cm³ or more and 5.00 g/cm³ or less.

According to such a configuration, it is possible to implement the insulator-coated soft magnetic powder 1 that can be used to produce a high-density dust core. Further, such a dust core makes it possible to implement a magnetic element having high magnetic properties.

In the insulator-coated soft magnetic powder 1 according to the embodiment, an amount of oxygen derived from the insulating coating 3 is 500 ppm or more and 7000 ppm or less in terms of mass ratio.

According to such a configuration, the insulation properties of the insulating coating 3 can be particularly enhanced. Therefore, even when a film thickness of the insulating coating 3 is thin, the insulator-coated soft magnetic powder 1 that has excellent insulation properties between the particles and can produce, for example, a green compact having excellent withstand voltage can be obtained. In addition, when the oxygen content derived from the insulating coating 3 is within the above range, adhesion of the insulating coating 3 to the soft magnetic particles 2 is increased, and for example, a green compact having excellent mechanical strength can be produced.

In the insulator-coated soft magnetic powder 1 according to the embodiment, the insulating coating 3 has an average thickness of 1 nm or more and 100 nm or less.

According to such a configuration, the insulation properties of the insulating coating 3 can be sufficiently ensured while the space factor of the insulating coating 3 in the dust core can be reduced and a filling rate of the soft magnetic particles 2 can be enhanced. In addition, when the surface of the soft magnetic particle 2 is uneven, the insulating coating 3 smooths out the unevenness and also contributes to making the particles closer to a spherical shape. Accordingly, the fluidity of the insulator-coated soft magnetic powder 1 can be further enhanced.

The dust core according to the embodiment includes the insulator-coated soft magnetic powder according to the embodiment. Accordingly, it is possible to obtain a dust core capable of implementing a magnetic element that achieves both magnetic properties, insulation properties, and a mechanical strength.

The magnetic element according to the embodiment includes the dust core according to the embodiment. Accordingly, it is possible to obtain a magnetic element that achieves both magnetic properties, insulation properties, and a mechanical strength.

The electronic device according to the embodiment includes the magnetic element according to the embodiment. Accordingly, it is possible to obtain an electronic device having high performance and a small size.

The insulator-coated soft magnetic powder, the dust core, the magnetic element, and the electronic device of the present disclosure are described hereinabove based on the preferred embodiments, but the present disclosure is not limited thereto.

In addition, in the above embodiment, a dust core is described as an example of an application of the insulator-coated soft magnetic powder according to the present disclosure, and the application examples are not limited thereto, and may also be magnetic devices such as magnetic fluids, magnetic heads, and magnetic shielding sheets. In addition, shapes of the dust core and the magnetic element are not limited to those shown in the drawings, and any shapes may be adopted.

In addition, the dust core and the magnetic element according to the present disclosure may be obtained by adding any component to the above-described embodiment.

### EXAMPLES

Next, specific examples of the disclosure will be described.

### 6. Preparation of Insulator-Coated Soft Magnetic Powder

First, a soft magnetic powder having a composition shown in Table 1 was prepared by a rotary water atomization method or a water atomization method. A production method and an average particle diameter of the soft magnetic powder are shown in Table 2.

Next, an insulating coating was formed on particle surfaces of the soft magnetic powder. Methods for forming the insulating coating, constituent materials, film thicknesses (average thickness), and oxygen contents are as shown in Table 2.

In this manner, the insulator-coated soft magnetic powders of the respective sample Nos. shown in Table 2 were obtained.

Thereafter, a specific surface area and a radial crushing strength of the obtained insulator-coated soft magnetic powder were measured. In addition, a “specific surface area ratio” was calculated based on the specific surface area of the soft magnetic powder before the insulating coating was formed. Measurement results and calculation results are shown in Table 2.

TABLE 1

| | Composition formula (atomic ratio) |
|---|---|
| Composition 1 | (Fe_{0.97}Cr_{0.03})₇₆(Si_{0.5}B_{0.5})₂₂C₂ |
| Composition 2 | Fe₇₉(Si_{0.3}B_{0.7})₁₉C₂ |

Composition 1 shown in Table 1 is a composition represented by a composition formula (Fe₁₋ₓCrₓ)ₐ(Si_{1-y}B_{y})_{100-a-b}C_{b} expressed in terms of atomic ratio [x=0.03, y=0.5, a=76.0, and b=2.0].

In Table 2 shown later, among the insulator-coated soft magnetic powders of respective sample Nos., those corresponding to the present disclosure are designated as “Examples”, and those not corresponding to the present disclosure are designated as “Comparative Examples”.

### 7. Evaluation of Insulator-Coated Soft Magnetic Powder

### 7.1. Relative Density of Molded Body

First, the insulator-coated: magnetic powder of each of Examples and Comparative Examples was mixed with 2.0 mass % of an epoxy resin and toluene relative to the mass of the powder, and an obtained mixture was dried at 50° C. for 1 hour and then crushed to obtain a granulated powder. Next, the obtained granulated powder is press-molded at a pressure of 294.2 MPa (3 t/cm²), and then heated at 150° C. for 3 hours to cure the epoxy resin. Accordingly, a molded body is obtained. The molded body is formed into an annular shape having an outer diameter of 14 mm, an inner diameter of 8 mm, and a thickness of 3 mm. Next, the mass of the obtained molded body was divided by the volume to calculate the density. Next, the obtained density was divided by a true density of the insulator-coated soft magnetic powder to calculate a relative density. Then, the relative density calculated was relatively evaluated in view of the following evaluation criteria. Evaluation results are shown in Table 2.
A: Relative density is 67% or more.
B: Relative density is 63% or more and less than 67%.
C: Relative density is less than 63%.

### 7.2. Permeability of Molded Body

First, for the insulator-coated soft magnetic powders of each of Examples and Comparative Examples, a molded body similar to that in 7.1 was prepared. Next, the permeability of the prepared molded body was measured. The permeability of the molded body is relative permeability, that is, effective permeability, obtained by preparing a closed magnetic circuit magnetic core coil in the above-described molded body and determining self-inductance of the coil. The permeability was measured using an impedance analyzer at a measurement frequency of 100 kHz. The number of turns of a winding was 7, and a wire diameter of the winding was 0.6 mm.

Then, the measured permeability was evaluated in view of the following evaluation criteria. Evaluation results are shown in Table 2. In addition, reference values in the following evaluation criteria are values set for each soft magnetic material, and a reference value for Samples Nos. 1 to 5 and 8 to 12 is that of Sample No. 7. A reference value for Sample No. 6 is Sample No. 13. Further, a reference value for Sample No. 14 is Sample No. 15. A reference value for Sample Nos. 16, 17, 19 is Sample No. 18.
A: A measured value of the permeability is 105% or more of the reference value.
B: A measured value of the permeability is 100% or more and less than 105% of the reference value.
C: A measured value of the permeability is less than 100% of the reference value.

### 7.3. Withstand Voltage

A withstand voltage of the insulator-coated soft magnetic powder of each of Examples and Comparative Examples was measured using the above method. Evaluation results are shown in Table 2.

TABLE 2

| | | Composition of insulator-coated soft magnetic powder | | | | |
|---|---|---|---|---|---|---|
| | | Soft magnetic powder | | | | |
| | | | | Average | Insulating coating | |
| | | Production | | particle | Film-forming | Constituent |
| Sample | | method | Composition | diameter | method | material |
| No. | Classification | — | — | pm | — | — |
| 1 | Example | Rotary water | Composition | 24.0 | Gas phase film | SiO₂ |
| | | | 1 | | formation method | |
| 2 | Example | Rotary water | Composition | 24.0 | Gas phase film | SiO₂ |
| | | | 1 | | formation method | |
| 3 | Example | Rotary water | Composition | 24.0 | Gas phase film | SiO₂ |
| | | | 1 | | formation method | |
| 4 | Example | Rotary water | Composition | 24.0 | Liquid phase film | SiO₂ |
| | | | 1 | | formation method | |
| 5 | Example | Rotary water | Composition | 24.0 | Mechanochemical | SiO₂ |
| | | | 1 | | method | |
| 6 | Example | Rotary water | Composition | 36.0 | Gas phase film | SiO₂ |
| | | | 1 | | formation method | |
| 7 | Comparative | Rotary water | Composition | 24.0 | None | None |
| | Example | | 1 | | | |
| 8 | Comparative | Rotary water | Composition | 24.0 | Liquid phase film | SiO₂ |
| | Example | | 1 | | formation method | |
| 9 | Comparative | Rotary water | Composition | 24.0 | Mechanochemical | Al₂O₃ |
| | Example | | 1 | | method | |
| 10 | Comparative | Rotary water | Composition | 24.0 | Liquid phase film | SiO₂ |
| | Example | | 1 | | formation method | |
| 11 | Comparative | Rotary water | Composition | 24.0 | Liquid phase film | SiO₂ |
| | Example | | 1 | | formation method | |
| 12 | Comparative | Rotary water | Composition | 24.0 | Mechanochemical | SiO₂ |
| | Example | | 1 | | method | |
| 13 | Comparative | Rotary water | Composition | 36.0 | None | None |
| | Example | | 1 | | | |
| 14 | Example | Inverted cone | Composition | 4.0 | Gas phase film | SiO₂ |
| | | water jet | 1 | | formation method | |
| 15 | Comparative | Inverted cone | Composition | 4.0 | None | None |
| | Example | water jet | 1 | | | |
| 16 | Example | Rotary water | Composition | 18.0 | Gas phase film | SiO₂ |
| | | | 2 | | formation method | |
| 17 | Example | Rotary water | Composition | 18.0 | Gas phase film | Al₂O₃ |
| | | | 2 | | formation method | |
| 18 | Comparative | Rotary water | Composition | 18.0 | None | None |
| | Example | | 2 | | | |
| 19 | Comparative | Rotary water | Composition | 18.0 | Mechanochemical | SiO₂ |
| | Example | | 2 | | method | |

| | Composition of insulator-coated soft magnetic powder | | | | | | | |
|---|---|---|---|---|---|---|---|---|
| | Insulating coating | | Specific | Specific | Radial | Evaluation result | | |
| | Film | Oxygen | surface | surface | crushing | Relative | | Withstand |
| Sample | thickness | content | area | area ratio | strength | density | Permeability | voltage |
| No. | nm | ppm | m²/g | % | MPa | — | — | V/mm |
| 1 | 16 | 1118 | 0.033 | 35 | 28 | A | A | 537 |
| 2 | 23 | 1606 | 0.028 | 29 | 24 | A | A | 628 |
| 3 | 34 | 2382 | 0.045 | 47 | 24 | A | A | 1155 |
| 4 | 21 | 1493 | 0.036 | 38 | 25 | A | A | 978 |
| 5 | 20 | 4553 | 0.092 | 96 | 14 | B | B | 428 |
| 6 | 45 | 1250 | 0.016 | 22 | 10 | B | B | 887 |
| 7 | 0 | 0 | 0.095 | — | 24 | B | — | 178 |
| 8 | 12 | 1183 | 0.381 | 401 | 7 | C | C | 583 |
| 9 | 46 | 4689 | 0.323 | 340 | 6 | C | C | 792 |
| 10 | 41 | 2933 | 0.464 | 488 | 6 | C | C | 1187 |
| 11 | 41 | 2933 | 0.662 | 696 | 8 | C | C | 1077 |
| 12 | 80 | 6540 | 0.124 | 131 | 9 | C | B | 324 |
| 13 | 0 | 0 | 0.074 | — | 7 | C | — | 154 |
| 14 | 10 | 6112 | 0.431 | 92 | 12 | B | B | 2700 |
| 15 | 0 | 0 | 0.470 | — | 11 | B | — | 198 |
| 16 | 27 | 2050 | 0.065 | 42 | 32 | A | A | 950 |
| 17 | 45 | 4452 | 0.123 | 80 | 18 | A | A | 488 |
| 18 | 0 | 0 | 0.154 | — | 15 | B | — | 184 |
| 19 | 60 | 5460 | 0.225 | 146 | 9 | C | C | 316 |

As shown in Table 2, it is found that the insulator-coated soft magnetic powder of each of Examples is capable of producing a green compact having high density and high insulation properties compared to the insulator-coated soft magnetic powder of each of Comparative Examples. Therefore, it is confirmed that, by using the insulator-coated soft magnetic powder of each of Examples, it is possible to implement a dust core having high mechanical strength and magnetic properties as well as high withstand voltage.

What is claimed is:

1. An insulator-coated soft magnetic powder comprising:
a soft magnetic powder; and
an insulating coating configured to cover a surface of a particle of the soft magnetic powder, wherein
the soft magnetic powder has an average particle diameter of 2.0 μm or more and 40.0 μm or less,
a specific surface area of the insulator-coated soft magnetic powder is 10% or more and 100% or less of a specific surface area of the soft magnetic powder alone, and
when the insulator-coated soft magnetic powder is mixed with 2.0 mass % of an epoxy resin and molded under a pressure of 294.2 MPa (3.0 t/cm²), an obtained first molded body has a radial crushing strength of 10 MPa or more.

2. The insulator-coated soft magnetic powder according to claim 1, wherein
the insulating coating contains an inorganic oxide.

3. The insulator-coated soft magnetic powder according to claim 1, wherein
when the insulator-coated soft magnetic powder is mixed with 2.0 mass % of an epoxy resin and molded at a pressure of 49.0 MPa (0.5 t/cm²), an obtained second molded body has a withstand voltage of 200 V/mm or more.

4. The insulator-coated soft magnetic powder according to claim 1, wherein
the specific surface area is 0.010 m²/g or more and 0.600 m²/g or less.

5. The insulator-coated soft magnetic powder according to claim 1, wherein
the particle is formed of an amorphous alloy material having a composition represented by a composition formula (Fe₁₋ₓCrₓ)ₐ(Si_{1-y}B_{y})_{100-a-b}C_{b} expressed in terms of atomic ratio, where x, y, a and b are 0<x≤0.06, 0.3≤y≤0.7, 70.0≤a≤81.0, and 0<b≤3.0.

6. The insulator-coated soft magnetic powder according to claim 5, wherein
a density of the first molded body is 4.40 g/cm³ or more and 5.00 g/cm³ or less.

7. The insulator-coated soft magnetic powder according to claim 1, wherein
an amount of oxygen derived from the insulating coating is 500 ppm or more and 7000 ppm or less in terms of mass ratio.

8. The insulator-coated soft magnetic powder according to claim 1, wherein
the insulating coating has an average thickness of 1 nm or more and 100 nm or less.

9. A dust core comprising:
the insulator-coated soft magnetic powder according to claim 1.

10. A magnetic element comprising:
the dust core according to claim 9.

11. An electronic device comprising:
the magnetic element according to claim 10.
